(19) United States
(12) Patent Application Publication
(10) Pub. No.: US 2012/0329631 A1
(43) Pub. Date: Dec. 27, 2012

(54) SCREEN BOWL CENTRIFUGE AND METHOD

(75) Inventors: Timothy S. QUINN, New Boston, NH (US); Michael REICHENBACH, Cologne (DE)

(73) Assignee: ANDRITZ SEPARATION INC., Arlington, TX (US)

(21) Appl. No.: 13/529,594

(22) Filed: Jun. 21, 2012

Related U.S. Application Data
(60) Provisional application No. 61/500,830, filed on Jun. 24, 2011.

(51) Int. Cl. B04B 7/16; B01D 43/00

(52) U.S. Cl. 494/36; 494/37

(57) ABSTRACT

A screen bowl centrifuge having first and second conically diverging screen sections. And a method of separating solids from liquid of a slurry includes feeding a slurry from a conveyor hub to a cylindrical section of a bowl extending about the conveyor hub; scrolling the solids along the cylindrical section in a first direction and a majority of the liquid in a second direction opposite the first direction using at least one helical blade extending from the conveyor hub; and sliding the solids from the cylindrical section along a conically diverging screen section of the bowl that includes a first conically diverging section and a second conically diverging section, the first conically diverging section extending at a first angle to the axis and the second conically diverging section extends at a second angle to the axis, and the first angle is different from the second angle.

### RELATED APPLICATION

This application claims the benefit of U.S. Application 61/500,830, filed Jun. 24, 2011, the entire contents of which are incorporated herein by reference.

### BACKGROUND OF THE INVENTION

The present invention relates to decanting screen bowl centrifuges that separate solids from liquid in a slurry.

Decanting centrifuges include a bowl rotatably driven about a horizontal or vertical axis and a conveyor. The bowl may be solid or screened. The conveyor may be a helical or worm screw. A slurry flows continuously into the bowl. The decanting centrifuge separates the solid from the liquid components of the slurry. The liquid in the slurry flows primarily in a first direction towards a liquid outlet port at a first end of the bowl. The conveyor prevents the heavier solids flowing in the same direction as the liquid. The conveyor rotates at a different speed than the bowl to scroll the heavier solids in the slurry to a discharge port at a second end of the bowl. In a screen bowl, the heavier solids are scrolled by the conveyor over an additional perforated screen section of the bowl prior to discharge. Conventional decanting centrifuges separate solids from liquids or segregate solids based on particle size. For example, solids having a large particulate size are discharged from one end of the bowl and smaller sized solids are discharged from the other end of the bowl with the liquids.

The torque required to drive the conveyor in a decanting centrifuge may require a substantial power drive. The friction of the solids being conveyed over the screen section can contribute to the torque required to drive the conveyor. An approach to reducing the torque requirement has been to give the screen section of the bowl a frusto-conical shape that diverges towards the solids outlet end of the bowl. A frusto-conical bowl reduces the conveyor torque requirements as the centrifugal forces on the solids assist passage of the solids along the diverging screen section. Reducing the conveyor torque requirement permits a reduction in the size and cost of the conveyor drive including, for example the gearbox, and a reduction in the total power consumption of the centrifuge. The use of the diverging screen section also provides a higher gravity force (G) factor and improves dewatering of the solids.

Increasing feed rates through a centrifuge can increase the solids cake pile heights in the bowl. Higher cakes can cause the solids in the bowl to retain moisture and reduce the dewatering function of the centrifuge. The diverging screen reduces the cake pile heights which counteract the tendency of increasing pile heights with faster feed rates.

FIG. 1 shows a conventional centrifuge 2 including a bowl 4 having a cylindrical section 6, a first frusto-conical section 8 that converges in a solids flow direction toward the longitudinal axis 34 of the centrifuge 2, and a second frusto-conical section 10 that diverges in the solids flow direction from the longitudinal axis 34. The second frusto-conical diverging section 10 is a screened section as indicated by the dotted line in FIG. 1. The lower portion of the bowl 4 is shown in FIG. 1.

The centrifuge 2 further comprises a conveyor 12 that includes a conveyor hub 14. The conveyor 12 has helical blades 16 extending radially from the conveyor hub 14. The hub 14 may be a cylindrical shaft rotated by a drive mechanism 38, e.g., an electrical motor and gearbox, show by the arrow in the figure. FIG. 1 shows only the lower half of the helical blades. The actual blades and bowel extend above the axis 34 as both rotate during operation of the centrifuge. The conveyor helical blades 16 extend along the entire length, or nearly the entire length, of the conveyor hub 14. The helical blades 16 may comprise a single, continuous helical blade or multiple blades extending around the conveyor hub 14.

The ends of the bowl 4 are supported by bearings 18 which allow the bowl to rotate about the axis 34. The conveyor 12, especially the hub 14, is also supported bearings or bushings. The conveyor drive unit 38 rotates the bowl 4 and the conveyor 12 at different speeds.

A feed pipe 20 is coaxial to the conveyor hub 14 and delivers a slurry 36 to a center chamber in the conveyor hub 14. The conveyor hub 14 comprises feed ports 22 that discharge the slurry 36 form the center chamber in the hub into the bowl 4. The slurry may flow from the hub into a center region of the bowl which is between the liquid outlet 24 and solids discharge 30. One end of the bowl 4 includes the liquid outlet 24 through which the liquid compound of the slurry is discharged from the centrifuge. The position of the liquid outlet below the axis 34 may be set to maintain a desired liquid level 26 of the slurry in the bowl 4.

The helical blades 16 of the conveyor 12 rotate about axis 34 to move, such as by scrolling, the solids of the slurry 36 in a solids movement direction 37 towards the solids discharge end 32 of the bowl 4. The rotation of the blades moves the solids in direction 37 an up the sloped ramp of the first frusto-conical converging section 8 of the bowl 4. Moving the solids up the ramp draws the solids up and out of the slurry. The peak of the ramp, e.g., the narrow throat 39 between the first and second frusto-conical converging sections 8, 10 extends above the liquid level 26. The helical blades do not move most of the liquid in the slurry as the liquid flows counter to the scrolling of the blades. As the helical blades move the solids up and over the throat 39, much of the liquid is separated from the solids. The solids continue to move, due to the rotation of the blades, from the throat to the second, frusto-conical diverging section 10 of the bowl 4. The diverging ramp of the second frusto-conical diverging section 10 is screen (illustrated by dotted lines) to allow for passage of liquid 28 and to retain solids as a cake on the screen. The blades 16 of the conveyor 12 move the solids down the ramp and to a solids outlet 30 of the second frusto-conical diverging screen section 10 at the discharge end 32 of the bowl 4.

The conveyor blades 16 extend along nearly the entire axial length of the conveyor hub 14 of the conveyor 12. The provision of the conveyor blades 16 along the entire length of the conveyor hub 14 requires that the drive unit 38 be capable of delivering a high torque required to rotate the blades. This high torque requirement results in an increased size and cost of a gear box associated with the drive unit 38. The provision of the conveyor blades 16 along nearly the entire length of the conveyor hub 14 also increases the weight of the conveyor, which results in increased wear in the bearings 18 and conveyor face.

FIG. 2 shows a centrifuge 2 according to another embodiment of the prior art includes a bowl 4 having a cylindrical section 6, a first, frusto-conical converging section 8, and a second, frusto-conical diverging section 10 in the form of a screen. The conveyor blades 16 of the centrifuge shown in FIG. 2 do not extend the length of the second frusto-conical diverging screen section. The centrifuge 2 in FIG. 2 includes a conveyor 12 that includes a conveyor hub 14 that receives a feed pipe 20 for feeding a slurry 36 into the conveyor hub 14. The conveyor hub 14 also includes feed ports 22 that feed the slurry 36 into the cylindrical section 6 of the bowl 4 The slurry may be fed to the junction of the cylindrical section 6 and the first frusto-conical converging section 8, or that the slurry may be fed onto the first frusto-conical converging section 8.

The bowl 4 includes a liquid outlet 24 that maintains the slurry at a liquid level 26 in the cylindrical section 6 of the bowl 4. The cylindrical section 6 and the first, frusto-conical converging section 8 may be imperforate, or solid. A short cylindrical screen section may also be provided between the first frusto-conical converging section 8 and the second frusto-conical diverging screen section 10. The conveyor hub 14 includes helical conveyor blades 16 along the length of the conveyor hub 14. The helical blades 16 may comprise a single continuous helical blade extending around the conveyor hub 14 or multiple blades.

The ramp of the second frusto-conical diverging screen section 10 includes a divergent angle 40 with respect to the longitudinal axis 34. The angle 40 is sufficiently large that the solids on the screen move down the ramp without aid of the helical blades. The angle 40 is selected to ensure that the solids slide over the screen as a cake. The frictional forces between the cake and the ramp are sufficient to slow the movement of the cake down the ramp to allow water in the cake to drain through the screen. The cake is pushed down the ramp by solids moving over the throat 39 and entering the second frusto-conical diverging screen section 10. The angle 40 may be selected to cause the cake of solids to slide in a controlled manner down the screen section 10 with minimal back pressure, but without allowing the solid cake to break loose from the screen section 10 and slide out of the centrifuge 2 in an uncontrolled manner. The divergent angle 40 should be selected such that the solids may be frictionally advanced over the screen section 10 in an amount of time that allows the additional liquid 28 to be removed from the solids. If the divergent angle 40 is too large, the solids will pass over the screen section 10 too quickly and the additional liquid 28 will not be sufficiently removed form the solids. The value of the divergent angle 40 will depend upon numerous factors, including the composition of the slurry 36 and the form of the screen section 10, including, for example, the mesh of the screen section 10, or the size of the openings in the screen section 10. The divergent angle 40 may have a value, for example, of 5° to 40°.

The conveyor 12 shown in FIG. 2 may not include helical conveyor blades 16 in the second, frusto-conical diverging screen section 10 of the centrifuge 2. Eliminating the conveyor blades 16 from the conveyor 12 in the region of the screen section reduces the torque requirements of the drive unit 38 of the centrifuge 2 and increases screen dewatering time. The elimination of the conveyor blades 16 in the divergent screen section 10 also reduces the weight of the conveyor 12, which reduces the load on the bearings 18, and reduces wear at the conveyor face. The centrifuge 2 shown in FIG. 2 provides improved dewatering of additional liquid 28 from the conically diverging screen section 10, reduces frictional forces along the conically diverging screen section 10 and may provide a thinner cake depth of the solids. The divergent angle 40 also increases the G factor on the product cake.

### SUMMARY OF THE INVENTION

A centrifuge has been conceived comprising a conveyor comprising a hub rotatable about an axis and at least one helical blade extending radially from the hub and in the axial direction of the hub. A bowl extends about the conveyor and is rotatable about the axis. The bowl comprises a cylindrical section extending from an upstream end of the conveyor and a conically diverging screen section extending to a downstream end of the conveyor, wherein the conically diverging section comprises a first conically diverging section and a second conically diverging section, the first conically diverging section extending at a first angle to the axis and the second conically diverging section extends at a second angle to the axis, and the first angle is different from the second angle. The bowl may also comprise a conically converging section between the cylindrical section and the conically diverging section.

A centrifuge has been conceived comprising: a conveyor comprising a hub rotatable about an axis and at least one helical blade extending radially from the hub and in the axial direction of the hub; a bowl extending about the conveyor and rotatable about the axis, the bowl comprising a first section, a second section and a throat between the first and second sections along the axis, the first section configured to receive a slurry from a slurry inlet to the centrifuge and having a liquid outlet at a first end of the bowl and the second section including a diverging screen section and a solids outlet, wherein a slope of the diverging screen section changes between the throat and the solids outlet.

A centrifuge has been conceived comprising a conveyor comprising a hub rotatable about an axis and at least one helical blade extending radially from the hub and in the axial direction of the hub; and a bowl extending about the conveyor and rotatable about the axis, the bowl comprising a cylindrical section extending from an upstream end of the conveyor and a conically diverging screen section extending to a downstream end of the conveyor. The conically diverging section comprises three or more sections, each section extending at an angle to the axis. At least one step is provided between at least two of the sections.

A method has been conceived of separating solids from liquid of a slurry comprises feeding a slurry from a conveyor hub to a cylindrical section of a bowl extending about the conveyor hub; scrolling the solids along the cylindrical section in a first direction and a majority of the liquid in a second direction opposite the first direction using at least one helical blade extending from the conveyor hub; and sliding the solids from the cylindrical section along a conically diverging screen section of the bowl that comprises a first conically diverging section and a second conically diverging section, the first conically diverging section extending at a first angle to the axis and the second conically diverging section extends at a second angle to the axis, and the first angle is different from the second angle. The at least one helical blade does not extend along the conically diverging screen section.

A method has been conceived of separating solids from liquid of a slurry comprising: feeding the slurry into a bowl rotating about a conveyor hub; scrolling the solids along a section of the bowl in a first direction towards a throat region of the bowl by rotating a helical blade extending into the slurry held in the bowl, while a majority of the liquid flows in an opposite direction to a liquid discharge port of the bowl; sliding the solids over a conically diverging screen section of the bowl which is downstream from the throat, wherein the conically diverging screen section has a slope which changes between the throat and a solids outlet of the bowl; extracting liquid from the solids sliding over the conically diverging screen section by passing the liquid through screen section, and discharging the solids through the solids outlet after extracting the liquid.

Other aspects, features, and advantages will become apparent from the following detailed description when taken in conjunction with the accompanying drawings, which are a part of this disclosure and which illustrate, by way of example, principles of the invention.

### SUMMARY OF THE DRAWINGS

The accompanying drawings facilitate an understanding of the various embodiments. In such drawings, in which like reference numbers indicate like elements and features:

FIG. 1 is a schematic cross-sectional diagram of a conventional screen bowl centrifuge wherein only a lower portion of the bowl is shown for purposes of illustration.

FIG. 2 is a schematic cross-sectional diagram of another conventional screen bowl centrifuge wherein only a lower portion of the bowl is shown for purposes of illustration.

FIG. 3 is a schematic cross-sectional diagram of a novel screen bowl centrifuge wherein only a lower portion of the bowl is shown for purposes of illustration.

FIG. 4 is a schematic cross-sectional diagram of another novel screen bowl centrifuge wherein only a lower portion of the bowl is shown for purposes of illustration.

FIG. 5 schematically illustrates forces applied to a cake of solids formed on the screen bowl as the cake is moved across the screen by a conveyor.

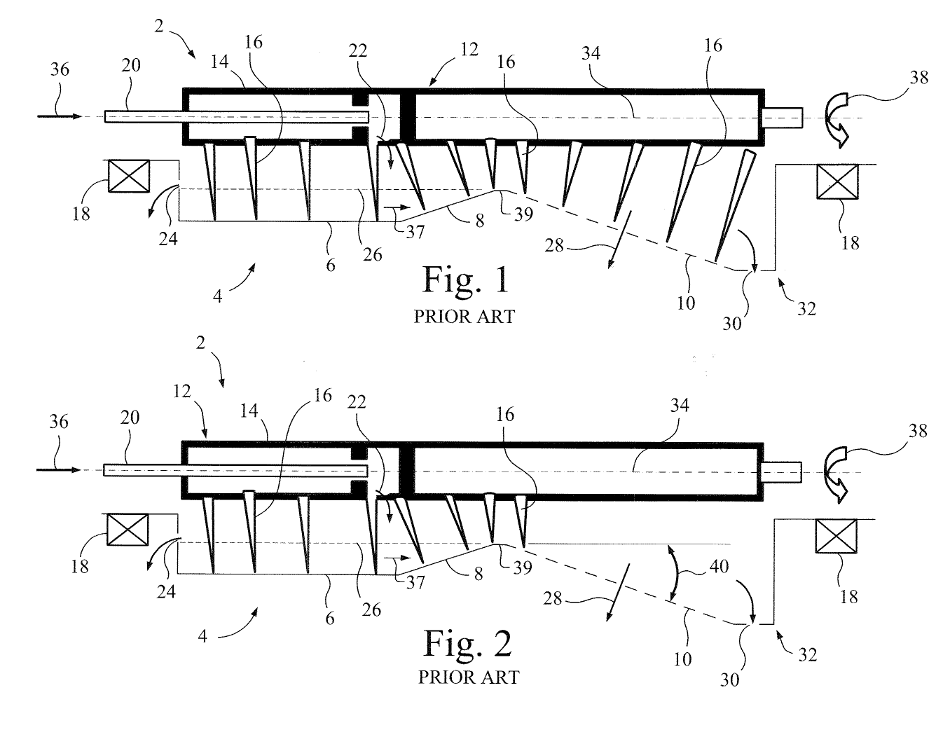

### DETAILED DESCRIPTION OF EMBODIMENTS OF INVENTION

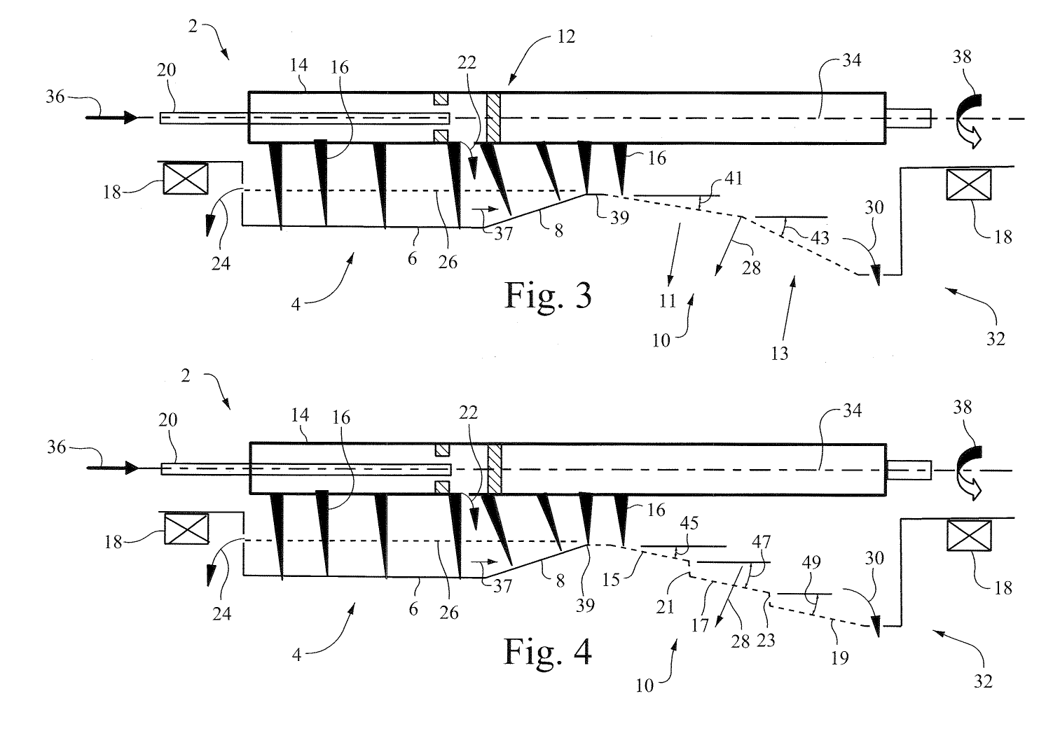

FIG. 3 shows a screen bowl centrifuge having a diverging conical section 10 that includes a first diverging conical section 11 provided at a first angle 41 with respect to the longitudinal axis 34 and a second diverging conical section 13 at a second angle 43 which is different from the first angle 41 such as by greater than 5 degrees. The diverging conical section 10 is shown as having two diverging conical sections 11, 13 at first and second angles 41, 43. The diverging conical section 10 of the bowl 4 may have more than two diverging conical sections and have cylindrical sections. The first angle 41 is less than the second angle 43 in the embodiment shown in FIG. 3. The diverging conical section having more than two sections, two or more of the sections may have angles that are equal or sections after the first section may have angles that are less than the angle of the first section.

FIG. 4 shows another embodiment of a screen bowl centrifuge having a diverging conical section 10 with a first diverging conical section 15 at a first angle 45 with respect to the longitudinal axis, a second diverging conical section 17 at a second angle 47 greater than the first angle, and a third diverging conical section 19 at a third angle 49 greater than the first angle 45 and the second angle 47. A first step 21 is provided between the first diverging conical section 15 and a second step 23 is provided between the second conical diverging section 17 and the third diverging conical section 19.

The solids in the slurry from a solid cake on the wall of the screen bowl. As the solid cake cascades over each step, the cake breaks which allows for increased dewatering of the solids and reduced sticking of the solids to the screen bowl. The solid cake structure reconstitutes on the screen bowl after each step. Although three diverging conical sections are shown and a step is shown between each diverging conical section, two or more diverging conical sections may be provided and a step may, or may not, be provided between each pair of diverging conical sections. The angles 45, 47, 49 may be equal to each other, or that any subset of the angles may be equal to each other, or that any subset of the angles may be different from each other.

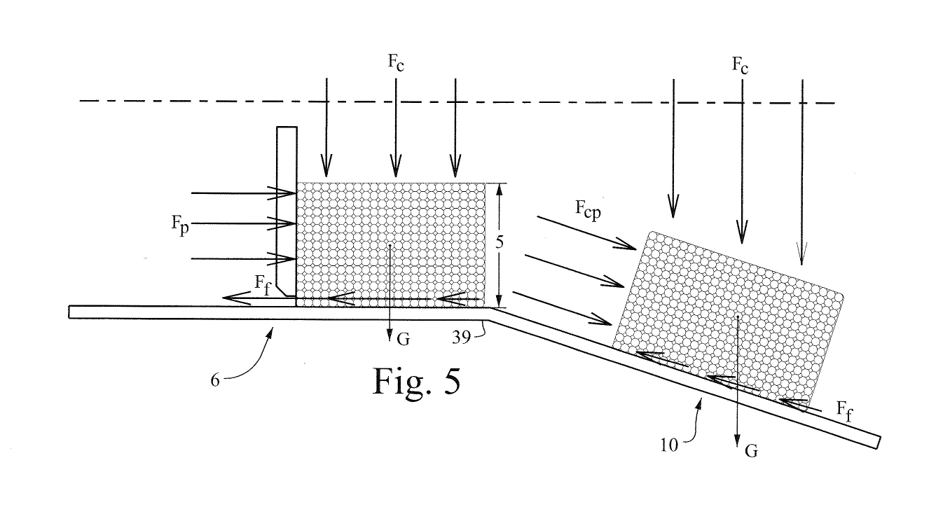

FIG. 5 illustrates that the forces acting on the solids cake sliding down the diverging conical section. The is affected by: the surface roughness of the screen bowl (affects friction between the screen and cake); the moisture content of the cake (affects the cohesion of the cake, the mass of the cake and the friction coefficient between the cake and screen); the distribution of particulate size of the solids (affects the cohesion and mass of the cake); the surface of the solid particulates in the cake (affects the cohesion of the cake); the temperature of the cake (affects the moisture content of the cake); the specific gravity of the solids in the cake (affects the mass of the cake) and the difference between the cake height on the conical screen and the cake height on the cylindrical screen. The forces acting to move the cake down the conical screen are shown in FIG. 5. The height of the cake is given by the competition between pushing force (Fp), friction force (Ff), centrifugal force (Fc), and the pushing force (Fcp) of the cake acting on the cake. The centrifugal force (Fc) on the diverging conical screen section is greater than the centrifugal force (Fc) on the cylindrical screen section. The greater centrifugal force (Fc) results in more compaction of the cake on the conical screen section. Additional compaction of the cake is desired because it aids in maintain cohesion of the cake and avoids having the cake break apart on the screen.

To provide controlled movement of the solids cake over the diverging conical screen section, the angles 41, 43, 45, 47, 49 of the screen section 10 should be set such that the cake slides in a controlled fashion due to the forces acting on the cake, which include centrifugal force (Fc), gravity (G) and pressure (Fp) from cake being added to the screen section. If the helical blades 16 do not extend to or to only a small portion of the screen section 10, the forces (Fc, G and Fp) act on the cake to overcome the friction (Ff) between the cake and the screen, which may be a steel screen, The centrifugal force (Fc) acting on the cake increases as the ramp of the screen section 10 diverges and the screen is further radially out from the axis. Due to the increasing centrifugal force, the height (h) of the cake on the screen section 10 reduces as the cake moves further away from the cake on the cylindrical screen section. In addition, the velocity of the cake on the screen section accelerates due to the greater centrifugal force.

If the helical blades 16 extend substantially the entire length of the screen section 10, the angles 41, 43, 45, 47, 49 of the diverging conical screen section may be less than the angle needed if the helical blades do not extend the length of the screen section. With the extended helical blades, the cake is moved by the blades the length of diverging conical screen section from the cylindrical screen section. The residence time of the cake on the screen section is determined by the scrolling movement of the blades. The torque required to drive a helical blade extending the length of the conical screen 10 is greater than the torque required for a helical blade that stops at the throat. If the cake is pushed from the cylindrical screen section, the torque on screw conveyor is increased by increasing the flow rate (more cake to push). However, no high torque with increasing feed flow rate was observed.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A centrifuge comprising:
a conveyor comprising a hub rotatable about an axis and at least one helical blade extending radially from the hub and in the axial direction of the hub;
a bowl extending about the conveyor and rotatable about the axis, the bowl comprising a first section, a second section and a throat between the first and second sections along the axis, the first section configured to receive a slurry from a slurry inlet to the centrifuge and having a liquid outlet at a first end of the bowl and the second section including a diverging screen section and a solids outlet,
wherein a slope of the diverging screen section changes between the throat and the solids outlet.

2. The centrifuge as in claim 1 wherein the changing slope includes an abrupt slope change between a first conically diverging section and a second conically diverging section.

3. The centrifuge as in claim 2 wherein the slope of the first conically diverging section is at an angle less than an angle of the slope of the second conically diverging section.

4. The centrifuge according to claim 3 wherein the angle of the slope of the first conically diverging section is at least five degrees smaller than the angle of the slope of the second conically diverging section.

5. The centrifuge of claim 2 wherein the abrupt slope change includes a step change in the slope of the first conically diverging section and the slope of the second conically diverging section.

6. The centrifuge according to claim 1 wherein the at least one helical blade does not extend along the conically diverging screen section.

7. The centrifuge according to claim 1 wherein the at least one helical blade does not extend along at least a portion of the conically diverging screen section.

8. The centrifuge according to claim 1 further comprising a cylindrical screen section or imperforate section at the throat between the conically converging section and the conically diverging screen section.

9. A method of separating solids from liquid of a slurry comprising:
feeding the slurry into a bowl rotating about a conveyor hub;
scrolling the solids along a section of the bowl in a first direction towards a throat region of the bowl by rotating a helical blade extending into the slurry held in the bowl, while a majority of the liquid flows in an opposite direction to a liquid discharge port of the bowl;
sliding the solids over a conically diverging screen section of the bowl which is downstream from the throat, wherein the conically diverging screen section has a slope which changes between the throat and a solids outlet of the bowl;
extracting liquid from the solids sliding over the conically diverging screen section by passing the liquid through screen section, and
discharging the solids through the solids outlet after extracting the liquid.

10. The method of claim 9 wherein the step of sliding the solids over the conically diverging screen section includes sliding the solids over an abrupt slope change between a first conically diverging section and a second conically diverging section.

11. The method of claim 10 wherein the slope of the first conically diverging section is at an angle less than an angle of the slope of the second conically diverging section.

12. The method of claim 10 wherein the abrupt slope change includes a step change in the slope of the first conically diverging section and the slope of the second conically diverging section, and the step of sliding includes sliding the solid over the step change.

13. The method according to claim 9 further comprising scrolling the solids through a conically converging section of the bowl after the cylindrical section and prior to the conically diverging screen section.

14. The method according to claim 9 wherein feeding the slurry comprises feeding the slurry from the conveyor hub to the cylindrical section of the bowl.

15. A centrifuge comprising:
a conveyor comprising a hub rotatable about an axis and at least one helical blade extending radially from the hub and in the axial direction of the hub, and
a bowl extending about the conveyor and rotatable about the axis, the bowl comprising a cylindrical section extending from an upstream end of the conveyor and a conically diverging section extending to a downstream end of the conveyor, wherein the conically diverging section comprises three or more screen sections, each screen section extending at an angle to the axis, and at least one step being provided between at least two of the screen sections.

16. The centrifuge according to claim 15 wherein each angle is different.

17. The centrifuge according to claim 15 wherein each angle is the same.

18. The centrifuge according to claim 15 wherein the at least one step includes a step between each screen section.

19. The centrifuge according to claim 15 wherein a first screen section of the screen sections is radially inward of the cylindrical section and another screen section of the screen sections is radially outward of the cylindrical section.

20. The centrifuge according to claim 15 wherein each of the screen sections of the conically diverging screen section.
